(19) United States
(12) Patent Application Publication
(10) Pub. No.: US 2010/0217482 A1
(43) Pub. Date: Aug. 26, 2010

(54) VEHICLE-BASED SYSTEM INTERFACE FOR PERSONAL NAVIGATION DEVICE

(75) Inventors: Cindy Hao Vogel, Hinsdale, IL (US); Mark Schunder, Dearborn, MI (US); Mark Shaker, Southfield, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/389,427

(22) Filed: Feb. 20, 2009

(51) Int. Cl. G01C 21/00; G06F 19/00

(52) U.S. Cl. 701/36; 701/200

(57) ABSTRACT

A vehicle-based system can communicate with a personal navigation device, to pass both automatic instructions and driver instructions to the personal navigation device. Using information and instructions passed from the vehicle-based system, the navigation device can be controlled to, among other things, provide directions, provide vehicle status warnings, and navigate without a GPS signal. Output from the personal navigation device can be delivered to the vehicle based system for playback through, for example, vehicle speakers.

### TECHNICAL FIELD

The illustrative embodiments generally relate to a vehicle based computing system interface for a personal navigation device.

### BACKGROUND AND SUMMARY

Personal navigation devices (PND), such as TOMTOM and GARMIN devices, use GPS coordinates to track the location of vehicles in which they are placed. They can also be carried around with a user and track movements, and can be used to determine an appropriate route of travel to a destination.

TOMTOMs also have BLUETOOTH capability, including the ability to connect to a BLUETOOTH phone and wirelessly receive phone calls made to the phone. They have an installed speaker that functions as an output, and a microphone pickup that receives voice input from a driver or other user.

TOMTOM also offers a series of plus services, that include access to traffic information, additional routes, points of interest, new voices and other services.

GARMIN offers similar compatibility, including the ability to have the navigation device function as a phone, place phone calls to the destination, SMS (text messaging) support, and an address book function.

### SUMMARY OF ILLUSTRATIVE EMBODIMENTS

According to one illustrative embodiment, a vehicle-based computing system wirelessly communicates with a PND. The system can be used to control the PND. In this embodiment, the vehicle-based computing system can be controlled by voice-commands from a driver. Voice-commands input to the vehicle-based system are converted to commands submitted to the PND, where the commands are executed. This allows the driver to voice-control the PND through use of the vehicle-based computing system.

In another illustrative embodiment, the vehicle-based system includes a series of settings that may be predetermined or otherwise selected by a user. Since the system interfaces with the PND, these settings can be transferred directly to the PND, changing its configuration, for example, when it is installed in different vehicles. For example, if a user had the vehicle-based system set to speak and respond in Spanish, then a PND placed in that vehicle would, through communication with the vehicle-based system, automatically configure itself to display/speak in Spanish. Because the vehicle-based system, which may have settings stored therein, is communicating with the PND, those settings may be automatically transferred to the PND.

Additionally, the vehicle-based system may relay information through the PND. In a further illustrative embodiment, the vehicle-based system is able to access various information about the vehicle itself. Examples include, but are not limited to, low air pressure, low gas, oil change needed, vehicle speed, etc. This information can be relayed to a PND and either be displayed as factual information, or be used with further functionality to provide additional user options.

In one non-limiting example, the vehicle speed may be conveyed to a PND. This can be useful in, for example, “urban canyons.” These are locations in a city/tunnel/etc. where towering buildings or other structures block a GPS signal. Through a technique known as “dead reckoning,” the PND can use information such as existing map data and conveyed vehicle speed to accurately determine where a vehicle is presently located, without actually being able to access a GPS signal to determine the location. The vehicle may also be able to provide a compass heading in at least one illustrative embodiment.

In another non-limiting example, a low-gas and/or low tire-pressure status may be conveyed to a PND. The PND could then, without user prompting, automatically recognize the potential problem, and ask if a user would like to navigate to the nearest gas station.

In yet a third non-limiting example, the vehicle can convey to the PND that the headlights have been turned on (indicating, for example, that the vehicle has determined it is now night-time). In response, the PND could ask the user if the user would like to use a color scheme more appropriate to night-time driving.

Through these and other uses of vehicle information, the PND can become a much more powerful tool. Further, if the vehicle uses the PND to display vehicle information, the display of the PND can be used much more effectively than the limited display space provided in most vehicles.

Depending on the vehicle-based system, various types of spoken communication with the PND may be possible. It could be the case that a vehicle-mounted button is pressed, informing the system and/or PND that a command is going to be input. The system may then wait for the input of a command. In another non-limiting example, a “dialogue” can be instructed, allowing a user to “have a conversation” with the PND through the vehicle-based system.

In addition to receiving information from the vehicle-based system, the PND can also communicate information back to the vehicle-based system. For example, the PND may send spoken directions to the vehicle-based system. The vehicle-based system can then, for example, silence or pause any presently playing audio (e.g. music, etc.) and play the directions through the car speakers. This prevents the two audio sources from interfering, and additionally, it allows a much louder and clearer form of directions to be delivered. After a direction has been delivered, the vehicle-based system resumes play of any suppressed audio.

Alternatively, if the PND is equipped with speech or sound playback capability, the PND could relay an instruction to the vehicle-based system instructing the system to silence the playing audio so the output of the PND could be more easily heard.

### BRIEF DESCRIPTION OF THE DRAWINGS

Other objects, aspects and characteristics of the illustrative embodiments will become apparent from the following detailed description of exemplary embodiments, when read in view of the accompanying drawings, in which:

FIG. 1 shows an exemplary illustrative vehicle-based system capable of interaction with a PND;

FIG. 2 shows an exemplary illustrative initialization process for communication between a vehicle-based system and a PND;

FIG. 3 shows an exemplary illustrative process for transfer of settings between a PND and a vehicle-based system;

FIG. 4 shows an exemplary illustrative process for transfer of menu commands from a PND system to a vehicle-based system;

FIG. 5 shows and exemplary illustrative process for input of a location to be traveled to through a vehicle-based system to a PND;

FIG. 6 shows an exemplary vehicle status prompt sent to a PND from a vehicle-based system;

FIG. 7 shows an exemplary process for dead reckoning in a PND using information from a vehicle-based system;

FIG. 8 shows an exemplary process for displaying turn icons on a vehicle control panel; and

FIG. 9 is an exemplary state diagram showing a non-limiting example of arbitration between two BLUETOOTH devices and receiving commands.

### DETAILED DESCRIPTION OF THE ILLUSTRATIVE EMBODIMENTS

The present invention is described herein in the context of particular exemplary illustrative embodiments. However, it will be recognized by those of ordinary skill that modification, extensions and changes to the disclosed exemplary illustrative embodiments may be made without departing from the true scope and spirit of the instant invention. In short, the following descriptions are provided by way of example only, and the present invention is not limited to the particular illustrative embodiments disclosed herein.

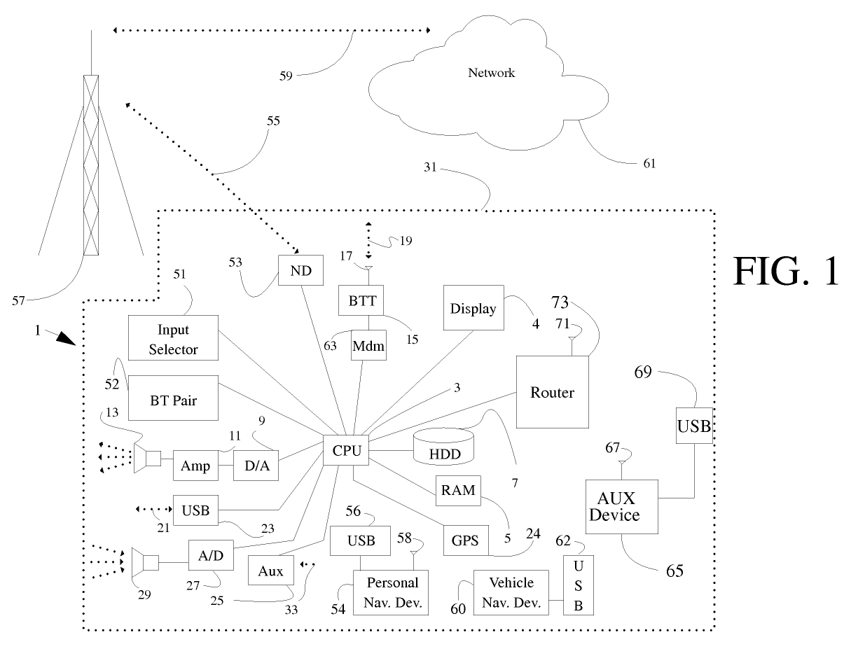

FIG. 1 illustrates exemplary system architecture of an illustrative onboard communication system usable for delivery of directions to an automobile. A vehicle enabled with a vehicle-based system such as a vehicle communication and entertainment system (VCES) may contain a visual front end interface 4 located in the vehicle. The user may also be able to interact with the interface if it is provided, for example, with a touch sensitive screen. In another illustrative embodiment, the interaction occurs through audible speech and speech synthesis.

In the illustrative embodiment 1 shown in FIG. 1 a processor 3 controls the operation of the system. Provided within the vehicle itself, the processor allows onboard processing of commands and routines. Further, the processor is connected to both temporary 5 and permanent storage 7. In this illustrative embodiment, the temporary storage is random access memory (RAM) and the permanent storage is a hard disk drive (HDD) or flash memory.

The processor is also provided with a number of different inputs for the user to interface with the processor. In this illustrative embodiment, a microphone 29, an auxiliary input 25, a USB input 23 and a BLUETOOTH input 15 are all provided. An input selector 51 is also provided, to allow a user to swap between various inputs. Input to both the microphone and the auxiliary connector is converted from analog to digital by a converter 27 before being passed to the processor.

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device or a USB device along the bi-directional data streams shown at 19 and 21 respectively.

In one illustrative embodiment, the system 1, uses the BLUETOOTH transceiver 15 to communicate 17 with a user's nomadic device 53 (e.g., cell phone, smart phone, PDA, etc.). The nomadic device can then be used to communicate 59 with a network 61 outside the vehicle 31 through, for example, communication 55 with a cellular tower 57.

Pairing a nomadic device 53 and the BLUETOOTH transceiver 15 can be instructed through a button 52 or similar input, telling the CPU that the onboard BLUETOOTH transceiver will be paired with a BLUETOOTH transceiver in a nomadic device.

Data may be communicated between CPU 3 and network 61 utilizing a broadband wireless data-plan associated with nomadic device 53. Alternatively, it may be desirable to include an onboard modem 63 in order to transfer data between CPU 3 and network 61 over the voice band. In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). If the user has a data-plan associated with the nomadic device, it is possible that the data- plan allows for broad-band transmission and the system could use a much wider bandwidth (speeding up data transfer). In still another embodiment, nomadic device 53 is replaced with a cellular communication device (not shown) that is affixed to vehicle 31.

In one embodiment, incoming data can be passed through the nomadic device via a data-over-voice or data-plan, through the onboard BLUETOOTH transceiver and into the vehicle's internal processor 3.

In addition to communicating with a nomadic device, the vehicle may also communicate with a PND. In some instances, the nomadic device and the PND may be one and the same (e.g., a cell-phone equipped with GPS capability). In other instances, the PND may be a separate device.

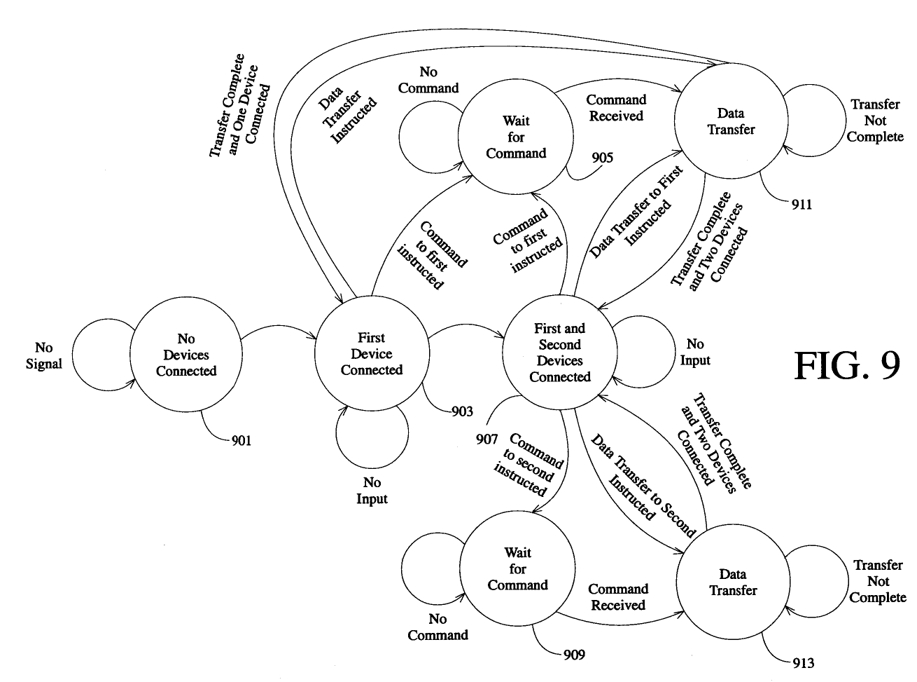

If more than one BLUETOOTH device is present, the system may have to arbitrate between communications to both devices, so that information flows smoothly to each device, and so that the proper information is sent to the proper devices. Additionally, the system may have to receive user input commands and will have to arbitrate between a state of sending information and receiving commands. FIG. 9 is an exemplary state diagram showing a non-limiting example of arbitration.

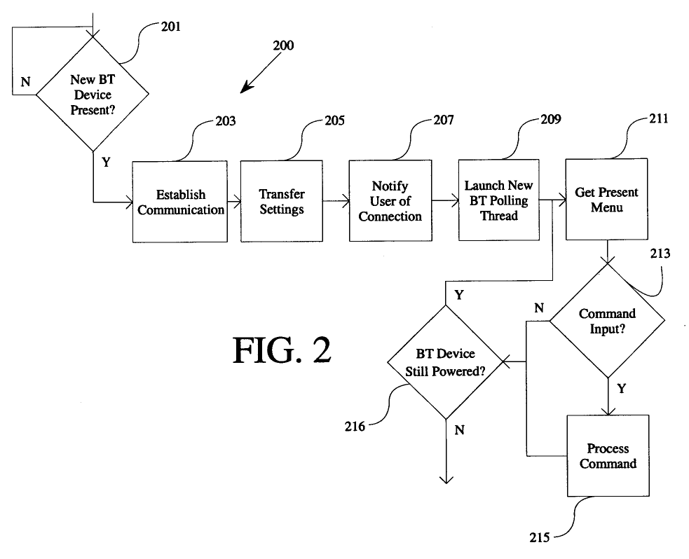

FIG. 2 shows an exemplary illustrative initialization process 200 for communication between a vehicle-based system and a PND. Once a vehicle-based system is powered, it can continually search for a BT device (or signal) to which it can connect 201. In at least one exemplary embodiment, the vehicle can only connect to devices which have been paired with the vehicle-based system. If a paired device is present, the vehicle-based system can then establish communication with the device 203.

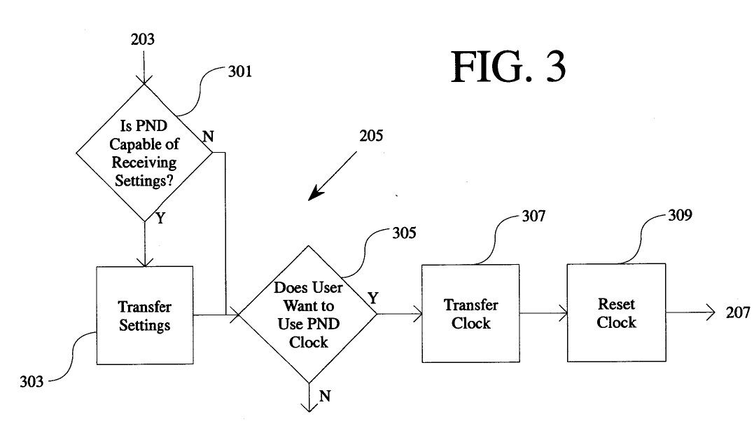

In one illustrative embodiment, the vehicle-based system transfers settings between the device and the system 205. This can be language, time, or any other suitable setting. This will be described in more detail with respect to FIG. 3.

After any settings are transferred 205, the system notifies the user that the device is connected 207. This will often take the form of an audio notification, such as a message or a tone, but could also be a visual notification.

In this illustrative embodiment, the system then proceeds to launch another BLUETOOTH polling thread 209. This allows the detection of additional BLUETOOTH devices. In one non-limiting example, a user may wish to connect a cell phone and a PND, both using BLUETOOTH, to the vehicle-based system. Since the system of this illustrative embodiment is continually polling for new connections, both devices should be detected and connected.

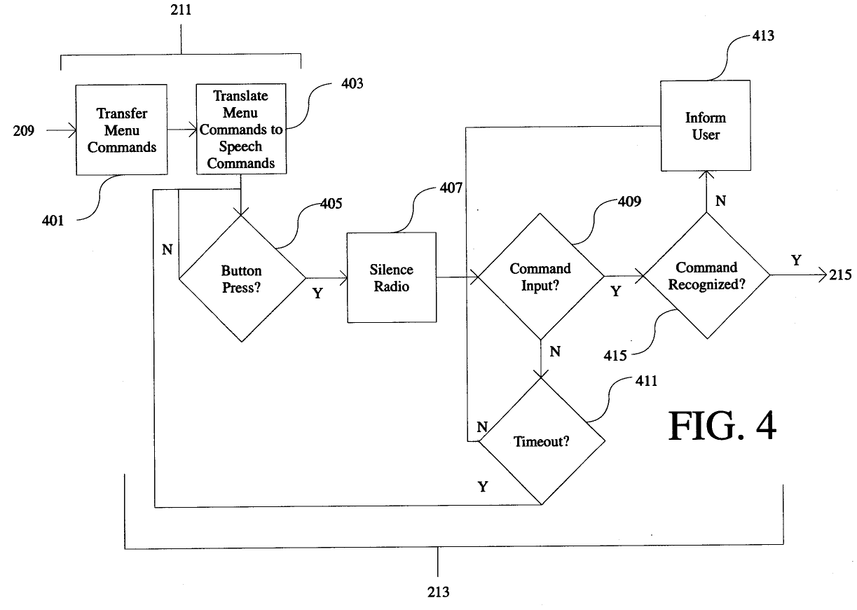

In many cases the PND will display a menu. In one illustrative embodiment, the vehicle-based system will download a menu from the PND 211. This is described in more detail with respect to FIG. 4.

After the menu has been downloaded or otherwise provided to the vehicle-based system, the system waits for a command from the user 213. If no command is input, the system checks to see if the BT device is still powered 216. As long as the device is still powered, the system checks to ensure the menu hasn't changed and continues to wait for a command. Once a command is provided, the system proceeds to process the command 215.

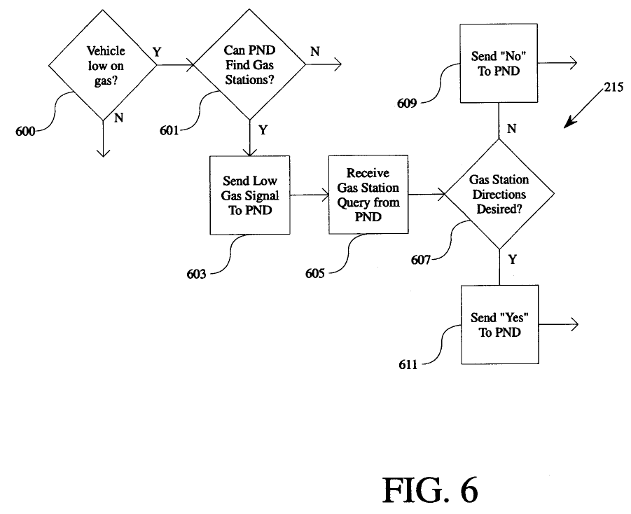

In some implementations, it may be desirable to have the PND perform analysis of the command. In these cases, the menu may not be downloaded, but rather the command will be received by the vehicle-based system and passed to the PND for analysis. The commands can be verbally or physically input. Certain commands may also be automatically input by the vehicle, without any user interaction. One non-limiting example of this is shown in detail in FIG. 6.

FIG. 3 shows an exemplary illustrative process for transfer of settings between a PND and a vehicle-based system 205. In this illustrative embodiment, either the vehicle-based system or the PND has one or more settings that would be desirable to transfer to the other of the two systems. These settings can include, but are not limited to, time of day, language, etc.

For example, a vehicle-based system may be programmed to operate in Spanish. Placing a PND in communication with this system may then result in the system operating in Spanish, unless the vehicle based settings are changed. Similarly, a PND may be programmed to operate in Spanish. Placing a PND operating in Spanish in communication with a vehicle programmed to respond to English may cause the vehicle to respond to Spanish instead. Ideally, one scheme or the other is chosen for a particular implementation, otherwise the two devices will likely conflict as both attempt to change the other.

Similarly, since the PND is GPS based, it can often dynamically change its clock as time zones are physically crossed. It could send a signal to the vehicle clock, instructing it to change when appropriate, to match the PND time. This allows vehicles to automatically change clock times when crossing time zones.

In this illustrative implementation, the system first checks to see if the PND is capable of receiving new settings 301. If it is not, the system then asks the user if the user would like to use the clock settings from the PND 305. If the PND is able to receive new settings, the vehicle-based system transfers appropriate settings to the PND 303. Then the vehicle-based system proceeds to checking if the user would like to use the clock settings from the PND 305. If the user would like to use these settings, the vehicle-based system receives the clock signal from the PND 307 and correspondingly resets the vehicle clock 309.

Other settings may include a home location, for example. If a vehicle-based system knows a user's home address, it may update the personal navigation device with a new home address that corresponds to the address stored in the vehicle. Numerous other settings are also possible.

FIG. 4 shows an exemplary illustrative process for transfer of menu commands from a PND system to a vehicle-based system 211. Many PNDs are provided with visual menus listing a variety of commands. Since PNDs are typically touch-sensitive, each displayed command is generally touched to activate it. This can, however present a problem to drivers, who may not wish to interact with a touch-based system while driving a car. Accordingly, the driver can use the vehicle-based system to input these menu commands.

In many instances, the vehicle-based system responds to voice commands. As another alternative, the vehicle-based system may respond to physically input commands. In at least one illustrative embodiment, these commands are input using one or more inputs on the steering wheel, so the driver does not have to remove his or her hands from the steering wheel in order to input the commands. Even if the PND is capable of receiving voice commands on its own, the menu path to these voice commands may require one or more touch inputs. Using the vehicle-based system, the driver may be able to command the PND to go into voice-processing mode without having to take his or her hands off of the wheel to input the instructions.

In one illustrative embodiment, displayed menu commands are transferred to the vehicle-based system 401. Although only the displayed commands are transferred in this embodiment, a flattened-menu system could also be transferred. In a flattened-menu system, the whole menu tree is transferred to the vehicle-based system, so that users can instruct the PND to perform known options that are not available on the present screen, without having to navigate to the screen where the options are available. A partial flattened menu or a list of common and/or popular commands could also be transferred in other embodiments.

Once the vehicle-based system receives the commands, in this illustrative embodiment, the commands are translated from text to speech commands 403. This allows spoken instructions to be compared against the speech commands to find matches. Another option would be to store the text commands and translate incoming speech to text, then to compare the text to the stored text. Any suitable means of comparing input commands to transferred commands is acceptable. In still a further illustrative embodiment, the spoken commands are transferred directly to the PND, and the analysis is performed by the PND.

According to this illustrative embodiment, a button (e.g. a button on the steering wheel) must be pressed before a command can be spoken 405. This helps prevent general noise inside the car (e.g. stereo, passengers, ambient road noise, etc.) from being interpreted as a command. It is possible, however, to provide the system without requiring the button press.

Once the button has been pressed, the system silences the radio 407 so that the radio noise will not be interpreted as a command. Then the system waits for a command to be spoken 409. In this illustrative embodiment, while the system is waiting, and a command has not been spoken, the system checks to see if the command waiting has timed out 211. If so, the system goes back to waiting for a button press. If a command is spoken, the system checks to see if the command matches an available speech command 415. If so, the command is processed 215, but if the command does not match a command, the system informs the user 413 and returns to wait for a valid command. Since passengers may make inadvertent noise while a command is being input, the system will continue to wait until a valid command is entered, although the system could return to, for example, waiting for a button press signaling another command.

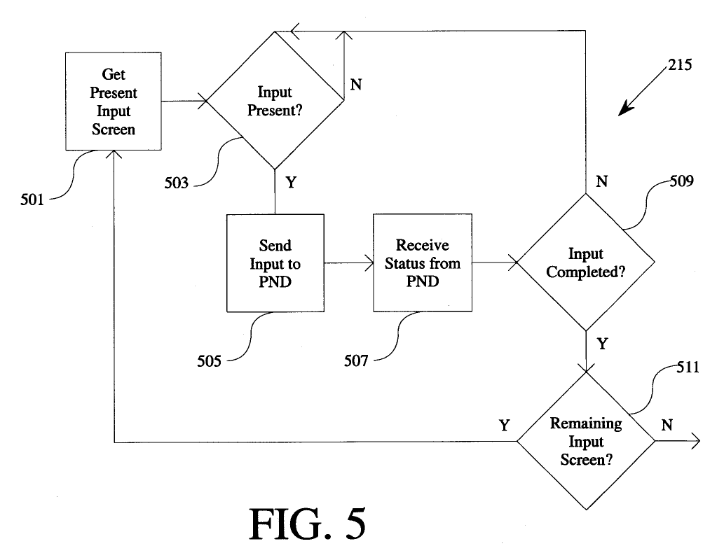

One type of command that may be input to a PND is a destination. FIG. 5 shows and exemplary illustrative process for input of a destination location through a vehicle-based system to a PND 215. Before reaching step 501, the user may have instructed the PND that a destination address is to be input. Then at 501, the vehicle-based system receives the PND's present input screen. In this illustrative embodiment, the input screen first asks a user to select a city. The user could either say the name of a city, or begin spelling the city, letter by letter. After an input is presented 503, be it a name or a letter, the system sends the input to the PND 505. Then the system receives a message from the PND as to whether more input is needed 507. For example, if the user said the city name, then the PND may send an message indicating that input is complete. But, if the user only said one letter, then a variety of possible choices may still remain, and the PND may send a message indicating that more input is needed.

The vehicle-based system checks the status message to determine if more input is needed. If so, it returns to wait for input. If no more input is needed, the system checks to see if any input screens are remaining 511. For example, if the address may be required to be input in the following format: city, street, number. Resultantly, after the city is input, the user still needs to input a street and address number. In this case, the system would receive the PND's next displayed input screen 501, and begin the process. On the other hand, if the PND is able to provide directions with the information present in the system, then no more input may be needed.

Numerous possibilities exist for the order of input and the methods of input, what is described here is but one exemplary non-limiting implementation.

It may also be desirable to send automatic vehicle status messages to a PND without user interaction. These messages can include, without limitation, tire pressure, gas level, day/night detection, and vehicle speed.

FIG. 6 shows an exemplary vehicle status prompt sent to a PND from a vehicle-based system 215. In this illustrative implementation, the vehicle is sending a low gas signal to the PND. First the vehicle checks to see if a fuel level is low 600. Then, the vehicle will determine if the PND is able to automatically find a nearest gas station 601. If so, the vehicle will send a message to the PND, informing it that the vehicle is low on fuel 603. Many PNDs are able to map routes to gas stations and other important locations without a specific address being provided.

According to this illustrative embodiment, once the PND receives the low gas signal, it will display a low gas message, and ask the user if they would like to map to the nearest gas station. This message is relayed in an audio fashion through the vehicle-based system 605 so the user is sure to hear the warning, although the message could simply be displayed on the PND. The user is asked if they would like to navigate to the nearest gas station 607, and the “yes” 611 or “no” 609 is relayed to the PND.

Additionally, the vehicle may instruct the PND to automatically plot a route to the nearest gas station if the remaining mileage drops below a certain threshold, assuming a gas station remains within the mileage remaining on the tank. This would help ensure that someone does not ignore the low gas message to their own detriment.

Additional “non-vehicle” data could also be relayed between the vehicle and the PND. For example, the driver could instruct a digital music selection to be played, and the PND could process that selection. Or, a phone contact could be selected for dialing and the instructions could be passed to the PND, either for dialing the contact or, for example, displaying the contact to be dialed to confirm the appropriate call is being placed. Similarly, incoming calls to a phone could have their associated caller IDs routed through the vehicle and displayed on the PND. Another feature might be to display climate control options on the PND. In one or more of these illustrative embodiments, an instruction is passed from the vehicle-based system to a device other than the PND. At the same time, the PND (or other device with a display) is caused to display some aspect relating to the instruction. In this manner, a second device display is used to display information about an instruction to a first device, and the information is relayed to both devices through the vehicle-based system.

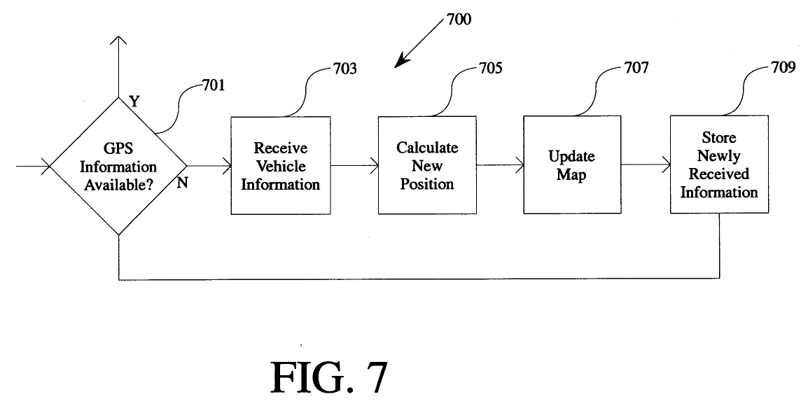

FIG. 7 shows an exemplary process for dead reckoning in a PND using information from a vehicle-based system 700. In certain areas, such as remote locations and “urban canyons”, where tall buildings block out a signal, a GPS signal may be occasionally lost by the PND. Even if it has lost the signal, however, the PND may still have a map of the area stored thereon. By using a technique called “dead reckoning,” the PND can predict where the vehicle is on a map until the GPS signal is available again.

In this illustrative embodiment, at least when the GPS information is unavailable 701, the vehicle-based system sends information to the PND and the PND receives the information it needs to perform the dead reckoning 703. Then, for example, based on a change in speed, time and heading, the PND can calculate a change in vehicle position 705 and update a displayed map 707.

Once the map is updated, the vehicle can store the presently transmitted speed, time and heading 709, so as to be able to complete the same calculation when the next set of information is transmitted. As long as the vehicle can continue to transmit this information, the dead reckoning can continue as long as needed until the GPS signal is restored.

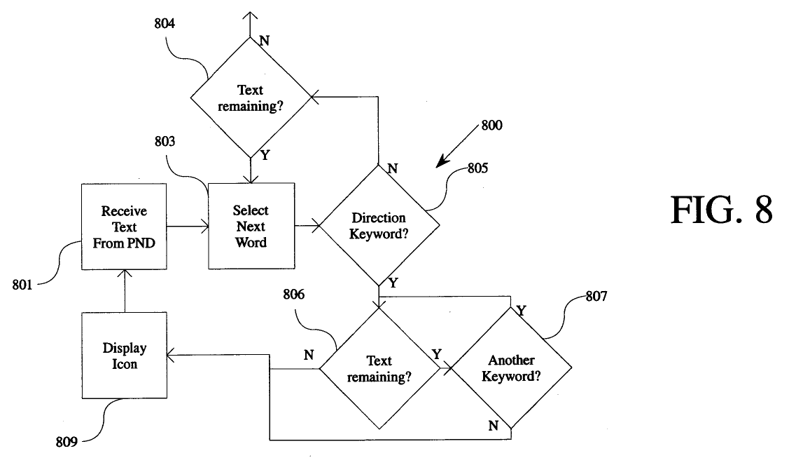

FIG. 8 shows an exemplary process for displaying turn icons on a vehicle control panel. In addition to displaying directional icons on a PND showing which direction to turn, it may be desirable to display the icons, or similar icons, on a vehicle instrument panel.

In one illustrative embodiment, the vehicle-based system receives a stream of text from the PND 801. In this illustrative embodiment, the stream of text is a stream providing the vehicle with a message to relay to the driver. Although the vehicle-based system may have other uses for the stream of text, such as relaying the message to the driver, the vehicle based system may also parse the stream for directional commands, by selecting one word at a time 803, for example.

If a directional keyword is not found 805, the system checks to see if any text is remaing 804. Remaining text results in selection of the next word in the text. Once a directional keyword is found 805, the system can check to see if text is remaining 806 and then check for additional following keywords (e.g., the word “slight” followed by the word “left”) 807. Once no more keywords are remaining in the detected string or no more text is remaining, the vehicle display can display an icon 809 representative of the instructed maneuver. This display can be done on a small LCD display, or any other suitable display.

In addition to parsing a stream of text, additional methods could include, but are not limited to: converting speech to text for parsing, recieving the directional portions separately, or any other suitable method of determining a directional portion to be displayed on a vehicle-based display.

FIG. 9 is an exemplary state diagram showing a non-limiting example of arbitration between two BLUETOOTH devices. In this illustrative embodiment, the system starts where no BLUETOOTH devices are connected 901. If no signal is received, the system stays in this state.

When a first BLUETOOTH signal is detected, the system connects to the first BLUETOOTH device 903. From this state, if a data transfer instruction is received, the system passes to an information transfer state 913. It remains in this state until the data send is complete. If only one device is connected, it returns to state 903.

Also, in state 903, a command can be input by the user. This transfers the system to a state where it is waiting for a command 905. As long as no command is received, the system waits in state 905. Once a command is received, the system passes to a data transfer state 913.

If a second BLUETOOTH signal is detected when the system is in state 903, the system passes to a state where both first and second BLUETOOTH devices are connected 907. Commands directed at the first device cause the system to pass to state 905, and commands to the second device send the system to state 909. Both states 905, 909 cause waiting for commands, and commands respectively send the system to states 913 or 911.

In either of the data transfer states 913, 911, the system waits until data transfer is complete, then returns to the appropriate state, depending on the number of devices connected.

Although one exemplary non-limiting state diagram has been presented, there are numerous possibilities for the arbitration process, and this illustrative embodiment is meant to be a non-limiting example.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A vehicle communication system comprising:
a computer processor in communication with persistent and non-persistent memory;
a local wireless transceiver in communication with the computer processor and configured to communicate wirelessly with one or more wireless devices located at the vehicle; and
speakers to provide audio output;
wherein the processor is operable to connect to the one or more wireless devices through the transceiver, and wherein at least one of the wireless devices is a personal navigation device (PND), wherein the processor is operable to communicate with the PND through the transceiver and to convey commands for controlling the PND input into a vehicle-based input.

2. The system of claim 1, wherein the processor is further operable to download at least a menu of the PND and output the menu via a vehicle system.

3. The system of claim 2, wherein the menu output is done using a display.

4. The system of claim 2, wherein the output is done using an audio output.

5. The system of claim 1, wherein the processor is operable to download a plurality of menu screens from a PND and present it to a user as a single menu having the available options from the plurality of menu screens.

6. A vehicle-based computing system comprising:
a computer processor in communication with persistent and non-persistent memory;
a local wireless transceiver in communication with the computer processor and configured to communicate wirelessly with one or more wireless devices located at the vehicle, wherein:
the processor is operable to communicate with a configurable portable device through the transceiver; and
the processor is operable to transfer one or more stored system settings to the portable device, wherein the portable device is further operable to adopt the one or more transferred settings.

7. The system of claim 6, wherein the portable device is a personal navigation device.

8. The system of claim 6, wherein the settings include a language setting.

9. The system of claim 6, wherein the settings include a time setting.

10. A vehicle-based computing system comprising:
a computer processor in communication with persistent and non-persistent memory;
a local wireless transceiver in communication with the computer processor and configured to communicate wirelessly with one or more wireless devices located at the vehicle, wherein:
the processor is operable to communicate with a portable device through the transceiver; and
the processor is operable to transfer a notification that a dark condition has been detected by a light sensor provided to the vehicle, and wherein the portable device is operable to offer an option to switch to a night-time or low-light setting when the dark condition notification is received.

11-14. (canceled)
